(19) United States
(12) Patent Application Publication
(10) Pub. No.: US 2022/0344827 A1
(43) Pub. Date: Oct. 27, 2022

(54) DIELECTRIC POLARIZATION CONVERTER

(71) Applicant: ROGERS CORPORATION, CHANDLER, AZ (US)

(72) Inventors: Daniel Pennock, Salem, MA (US); Sara G. Canzano, Boston, MA (US); William Blasius, Charlton, MA (US); Shailesh Pandey, Woburn, MA (US); Kristi Pance, Auburndale, MA (US); Gianni Taraschi, Arlington, MA (US)

(21) Appl. No.: 17/728,349

(22) Filed: Apr. 25, 2022

Related U.S. Application Data
(60) Provisional application No. 63/179,672, filed on Apr. 26, 2021.

(51) Int. Cl. H01Q 15/24

(52) U.S. Cl. CPC H01Q 15/242

(57) ABSTRACT

In an aspect, a polarization converter comprises a plurality of alternating high Dk layers and low Dk layers that alternate along an x-direction; wherein neighboring broad surfaces of the respective high Dk layers and low Dk layers are bonded together. In another aspect, a polarization converter can comprise a plurality of alternating high Dk layers and low Dk layers that alternate along a radial direction; wherein neighboring broad surfaces of the respective high Dk layers and low Dk layers are bonded together. The polarization converter is capable of converting an incoming electromagnetic wave to an outgoing electromagnetic wave having a different polarization.

### CROSS-REFERENCE TO RELATED APPLICATION

This application claims the benefit of U.S. Provisional Patent Application Ser. No. 63/179,672 filed Apr. 26, 2021. The related application is incorporated herein in its entirety by reference.

### TECHNICAL FIELD

The present application relates to a polarization converter that can be used to convert linearly polarized waves into circularly polarized waves and vice versa.

### BACKGROUND

With an increase in radar and satellite communications, the demand for circularly polarized antennas has been increasing as these antennas can be used when the orientation of a linearly polarized signal cannot be easily predicted. Circular polarization can be created by the antenna itself or through the use of a polarizer located proximate to an antenna. Polarizers (such as meander-line polarizers) can convert linearly polarized waves into circularly polarized waves and vice versa. For example, an incident linearly polarized wave (Eᵢₙ) making a 45 angle with the meander-line x-axis can be divided into two equal orthogonal components, parallel (Ell) and orthogonal (E_{⊥}) to this x-axis. The meander-line can be considered as an inductive element for E_{∥} that will be delayed by going through the polarizer and a capacitive one for E_{⊥} that will be advanced, the effect of which results in a transmission coefficient differential phase shift between the two orthogonal components of the incident electric field. By adjusting the differential phase shift and the angle of the meander line axis, input polarization can be altered. For example, a differential phase shift of nearly 90° between the two field components at the polarizer output can be obtained and if Eli and E_{⊥} have the same amplitude, the polarizer will generate a circular polarization.

While polarizers that can convert linearly polarized waves and circularly polarized waves exist, improvements in both the material and the conversion capabilities are desired.

### BRIEF SUMMARY

Disclosed herein is a polarization converter.

In an aspect, a polarization converter comprises a plurality of alternating high Dk layers and low Dk layers that alternate along an x-direction; wherein the respective layers each independently have a first broad surface and a second broad surface in the y-z plane; wherein neighboring broad surfaces of the respective high Dk layers and low Dk layers are bonded together; wherein the polarization converter is capable of converting an incoming electromagnetic wave to an outgoing electromagnetic wave having a different polarization.

In another aspect, a polarization converter can comprise a plurality of alternating high Dk layers and low Dk layers that alternate along a radial direction; wherein a height in the axial, z-direction is optionally less than the diameter in the radial direction; wherein the respective layers each independently have a first broad surface and a second broad surface; wherein neighboring broad surfaces of the respective high Dk layers and low Dk layers are bonded together; wherein the polarization converter is capable of converting an incoming electromagnetic wave to an outgoing electromagnetic wave having a different polarization.

In an aspect, an article can comprise the polarization converter.

In another aspect, a method of making the polarization converter can comprise bonding neighboring layers of a multilayer stack of a plurality of alternating low Dk layers and high Dk layers to form the polarization converter.

In yet another aspect, a method of making the polarization converter can comprise spiraling at least one low Dk layer and at least one high Dk layer around an x-axis and bonding the neighboring layers together to form the polarization converter; or spiraling one of a low Dk layer or at least one high Dk layer around an x-axis with an intervening space between the neighboring layers; and filling the intervening space with the other of the low Dk layer and the high Dk layer.

The above described and other features are exemplified by the following figures, detailed description, and claims.

### BRIEF DESCRIPTION OF THE DRAWINGS

The following Figures are exemplary embodiments, which are provided to illustrate the present disclosure and wherein the like elements are numbered alike.

FIG. 1 is an illustration of an orthogonal view of an aspect of a polarization converter including alternating high Dk layers and low Dk layers;

FIG. 2 is an illustration of a planar view of a polarization converter in the x-y plane;

FIG. 3 is an illustration of a planar view of a polarization converter in the x-z plane including intervening adhesive layers;

FIG. 4A is an illustration of a planar view of a polarization converter in the x-z plane including anti-reflective layers;

FIG. 4B is an illustration of a planar view of a polarization converter in the x-z plane including anti-reflective layers;

FIG. 5 is an illustration of showing the incident angle is relative the normal to the polarization convertor;

FIG. 6 is an illustration of an article including a polarization converter and an antenna;

FIG. 7 is an illustration of a multilayer stack;

FIG. 8 is an illustration of a bonded stack prior to severing;

FIG. 9 is an illustration of a method for roll-to-roll processing of a multilayer stack;

FIG. 10 is an illustration of a spiraling polarization converter with constant radial thicknesses of the respective high Dk and low Dk layers; and

FIG. 11 is an illustration of a spiraling polarization converter with increasing radial thicknesses of the respective high Dk and low Dk layers.

### DETAILED DESCRIPTION

A polarization converter was developed that can be used in microwave, radio frequency, and mm-wave applications that enables system designers to easily and effectively manipulate electromagnetic (EM) radiation polarization. The polarization converter comprises alternating layers of a high permittivity (Dk) material and a low Dk material, wherein the respective neighboring layers of the high Dk material and the low Dk material are bonded to each other. It is noted that bonding the neighboring layers of the high Dk material and the low Dk material has not generally been considered due concerns that such bonding would ultimately impact performance of the polarization converter, for example, by changing the permittivity of the converter or increasing the loss. The polarization converter can offer efficient, low-loss conversion of impinging linearly polarized electromagnetic radiation to circular polarized electromagnetic radiation for wide bandwidth and large incident angle, thereby enabling wide field-of-view. The polarization converter can be utilized in a variety of frequency ranges, currently spanning from X band to W band. The polarization converter can be used in communications, such as satellite and cellular, radar, or mm-wave imaging.

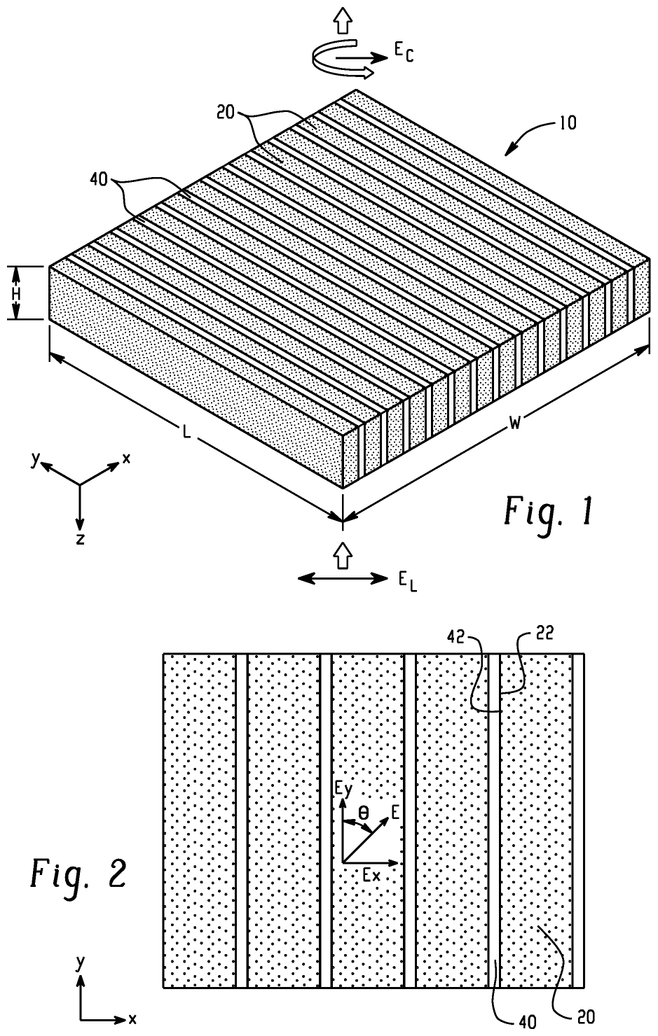

FIG. 1 is an illustration of an aspect of a polarization converter 10 that includes a plurality of alternating high Dk layers 40 and low Dk layers 20 that alternate along an x-direction, where the permittivity of the high Dk layers 40 is greater than the permittivity of the low Dk layers 20. For example, a permittivity of a specific high Dk layer 40 can be greater than the permittivity of the two neighboring low Dk layers 20. A height, H, of the polarization converter in the z-direction can be less than the width, W, in the x-direction and the length, L, in the y-direction. The respective high Dk layers 40 and low Dk layers 20 each independently have a first broad surface and a second broad surface in the y-z plane that are bonded to neighboring broad surfaces of an opposite of the high Dk layers and low Dk layers. The end-most layers of the polarization converter can each independently be either of the high Dk layer or the low Dk layer, where the outermost surfaces are not bonded to another high Dk layer or low Dk layer.

FIG. 2 illustrates that when the incident electric field, E, generated from a source passes through the polarization converter, it can be resolved into two orthogonal components, Eₓ and E_{y}. Since the polarization converter combines with at least two different dielectric materials, the fields of Eₓ and E_{y} travel along the polarization converter in the different regions at different velocities resulting in a phase shift between the two fields. This shift allows the polarization converter to convert an incoming electromagnetic wave to an outgoing electromagnetic wave having a different polarization. For example, FIG. 1 further illustrates that the polarization converter is capable of converting a linear electromagnetic wave, E_{L}, entering from a first side of the polarization converter illustrated by the arrows to a circular electromagnetic wave, Ec, exiting from a second side of the polarization converter. It is understood that the converse is also possible where the polarization converter is capable of converting a circular electromagnetic wave, Ec, to a linear electromagnetic wave, E_{L}. FIG. 2 illustrates an aspect where the linear electromagnetic wave is converted to a circular electromagnetic wave or vice versa, where the electric field in-plane (xy-plane) component has an angle θ that is 45° or 135° with respect to the length of the layers in the y-direction, and wherein the Eₓ and E_{y} components are imparted with a relative phase shift of 90° upon exiting the polarization convertor. Alternatively, the polarization converter can be used to convert the handedness of a circular polarization or transverse electric to transverse magnetic, for example, from a left hand circular polarization to a right hand circular polarization by adjusting the relative phase shift to be 180°. The angle θ can be altered by a mechanical rotation of at least one of the polarization converter or the antenna.

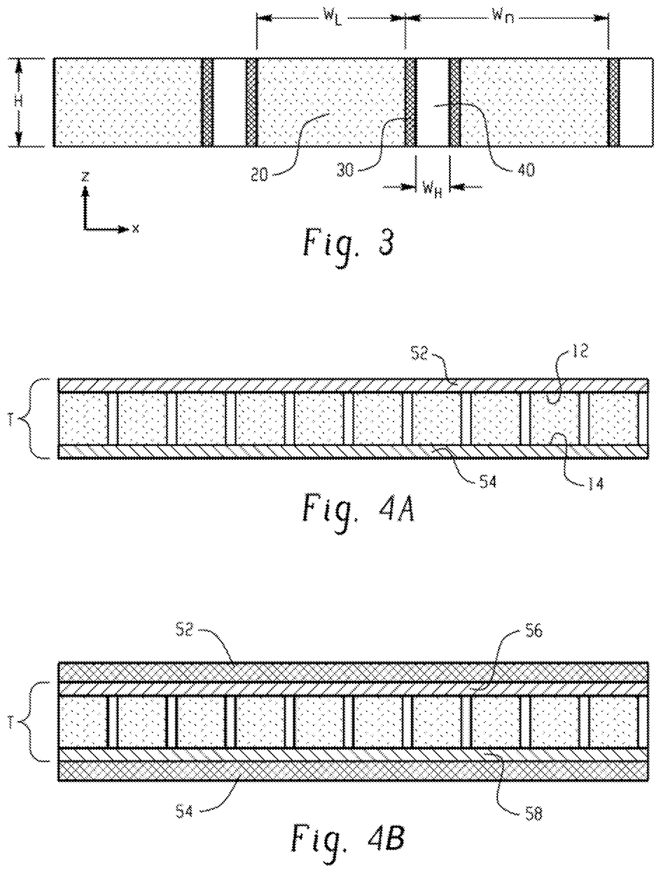

The differential phase shift of the polarization converter can be determined by the dimensions of respective layers, the thickness of the polarization converter, and the relative permittivity of the dielectric layers. FIG. 3 illustrates several of the relevant parameters, where W_{L} is the width of the low Dk layer 20, W_{H} is the high Dk layer 40, and H is the height of the polarization converter. The width W_{L} of the respective low Dk layers 20 can each independently be 0.2 to 50 millimeters (mm), or 0.5 to 10 mm, or 0.5 to 2 mm. The width W_{H} of the respective high Dk layers 40 can each independently be 0.1 to 50 mm, or 0.1 to 20 mm, or 0.1 to 0.5 mm. A ratio, η, of the width W_{L} to the width W_{H} (W_{L}/W_{H}) can be greater than 0 to 100, or 0.1 to 20, or 1 to 15, or 3 to 9.

The height H in the z-direction of the polarization converter can be 0.1 to 100 mm, or 0.5 to 20 mm. The width W in the x-direction of the polarization converter can be greater than or equal to 25 centimeters, or 25 to 100 centimeters. A ratio of the width W to the height H can be greater than or equal to 2, or greater than or equal to 10, or 2 to 2,000. The length L in the y-direction of the polarization converter can be greater than or equal to 25 centimeters, or 25 to 100 centimeters. A ratio of the length L to the height H can be greater than or equal to 2, or greater than or equal to 10, or 2 to 2,000. A ratio of the length L to the width W can be 5:1 to 1:5, or 2:1 to 1:2.

Each low Dk layer 20 independently can have a permittivity of less than or equal to 3, or 1 to 2 at a frequency of operation. As used herein, the permittivity is measured by a split post dielectric resonator, a cavity resonator, or transmission/reflection measurements. Each low Dk layer 20 independently can comprise a dielectric material. The dielectric material in each low Dk layer 20 independently can be a foam, can include perforations, or can be solid. Each low Dk layer 20 independently can have a porosity of 0 to 99 volume percent (vol %), 0 to 60 vol %, or 20 to 50 vol % based on the total volume of the low Dk layer. Each low Dk layer 20 can comprise an aerogel, for example, having a porosity of 99 to 99.9 vol % based on the total volume of the aerogel. The aerogel can constitute an entire low Dk layer 20, can be present as a filler, or can be located in perforations of the low Dk layer 20. The aerogel can be organic or inorganic, and can comprise at least one of a polyurea, a polyurethane, a resorcinol-formaldehyde polymer, a polyisocyanate, an epoxy, carbon, a metal oxide, a metalloid oxide, boron nitride, graphene, silica, or vanadia.

If a low Dk layer 20 comprises a foam, the foam can comprise at least one of a chemically blown foam, a physically blown foam, or a syntactic foam that includes a plurality of hollow spheres. The foam can comprise one or more of the dielectric materials, for example, as listed below. Specific examples of foam dielectric materials include polyurethane foams such as PORON CONDUX PLUS™, which is commercially available from Rogers Corporation, Rogers, Conn.; polyolefin foams (for example, comprising polyethylene or polypropylene); polystyrene foams; poly(phenylene ether) foams; polyimide foams; polylactic acid foams; or silicone foams. The foam can be crosslinked after foaming, for example, by gamma irradiation or electron beam exposure. The foam can comprise a syntactic foam that refers to a solid material that is filled with hollow particles, in particular spheres. The hollow particles can comprise at least one of ceramic hollow particles, polymeric hollow particles, or glass hollow particles (such as those made of an alkali borosilicate glass). The syntactic foam can comprise 1 to 70 vol %, or 5 to 70 vol %, or 10 to 50 vol % of the hollow particles based on the total volume of the foam layer. The microparticles can have a mean diameter of less than or equal to 300 micrometers, or 15 to 200 micrometers, or 20 to 70 micrometers. Compared to other types of foams, syntactic foams can have one or more of a better mechanical stability, a better coefficient of thermal expansion matching with the via material, or a reduced moisture absorption.

Each high Dk layer 40 independently can have a permittivity of greater than 3, or 4 to 25, or 8 to 15 determined at a frequency of operation. Each high Dk layer 40 independently can comprise a high Dk material. The high Dk material can comprise a dielectric material and a high Dk filler having a permittivity that is greater than the permittivity of the dielectric material in the high Dk material. The high Dk filler can comprise at least one of titanium dioxide (such as rutile and anatase), barium titanate, strontium titanate, silica (including fused amorphous silica), corundum, wollastonite, Ba₂Ti₉O₂₀, solid glass spheres, hollow glass spheres, hollow ceramic spheres, quartz, boron nitride, aluminum nitride, silicon carbide, beryllia, alumina, alumina trihydrate, magnesia, mica, talc, nanoclay, or magnesium hydroxide. Optionally, the dielectric filler can be surface treated with a silicon-containing coating, for example, an organofunctional alkoxy silane coupling agent. A zirconate or titanate coupling agent can be used. Such coupling agents can improve the dispersion of the filler in the polarization converter and reduce water absorption of the finished article. The polarization converter can comprise 10 to 80 vol %, or 20 to 60 vol %, or 40 to 60 vol % of the high Dk filler based on the total volume of the respective high Dk layer 40.

The dielectric material can comprise a thermoplastic or a thermoset polymer. The dielectric material, for example, of a low Dk layer 20 (such as a polymer foam layer) or of a high Dk layer 40 can comprise at least one of a polyacetal, a poly(C₁₋₆ alkyl)acrylate, a polyacrylic, a polyamide, a polyamideimide, a polyanhydride, a polyarylate, a polyarylene ether, a polyarylene sulfide, a polybenzoxazole, a polycarbonate, a polyester (such as an alkyd), a polyetheretherketone, a polyetherimide, a polyetherketoneketone, a polyetherketone, a polyethersulfone, a polyimide (such as a polyetherimide), a poly(C₁₋₆ alkyl)methacrylate, a methacrylic polymer, a polyphthalide, a polyolefin (such as a fluorinated polyolefin such as polytetrafluoroethylene), a polysilazane, a polysiloxane, a polystyrene, a polysulfide, a polysulfonamide, a polysulfonate, a polythioester, a polytriazine, a polyurea, a polyvinyl alcohol, a polyvinyl ester, a polyvinyl ether, a polyvinyl halide, a polyvinyl ketone, a polyvinylidene fluoride, a polyvinyl ester, an epoxy, a phenolic polymer, a polyurethane, or a silicone. The dielectric material, for example, of a low Dk layer 20 (such as a polymer foam layer) or of a high Dk layer 40 can each independently comprise at least one of a polyurethane, a polyimide, a polyolefin (for example, a polyethylene or a polypropylene), a poly(meth)acrylamide, a polyetherimide, a fluoropolymer, a polybutadiene, a polyisoprene, a polyetheretherketone, a polyester (for example, a polyethylene terephthalate), or a polystyrene.

The dielectric material, for example, of a low Dk layer 20 (such as a polymer foam layer) or of a high Dk layer 40 can comprise a polyolefin. The polyolefin can comprise at least one of a homopolymer such as polyethylene (such as low density polyethylene and high density polyethylene), polypropylene, or an alpha-olefin polymer (such as a C₃₋₁₀ alpha-olefin polymer), or a copolymer comprising ethylene, propylene, or C₃₋₁₀ alpha-olefin units, or a partially or fully halogenated analog of any of the foregoing. The polyolefin can comprise a low density polyethylene (LDPE) having a density of 0.91 to 0.93 grams per centimeter cubed (g/cc). The respective low Dk layers 20 can comprise the same or different dielectric material. The respective high Dk layers 40 can comprise the same or different dielectric material.

At least one of the alternating high Dk layers or low Dk layers can have a patterned surface. The respective surfaces can be patterned by removing a portion of the dielectric material on a surface of the layer. Patterning of the surface(s) can help reduce the reflection of the incident electromagnetic radiation.

The neighboring layers of the low Dk layers and the high Dk layers are bonded together. At least some of the neighboring broad surfaces of the neighboring high Dk layers and low Dk layers can be in direct physical contact with each other. For example, FIG. 2 illustrates that a first surface of the low Dk layer 22 can be in direct physical contact with a first surface of the high Dk layer 42. When the neighboring layers are in direct physical contact, the neighboring layers can be solvent bonded, laminated (for example, via heat and pressure or via lamination of neighboring prepregs), printed (for example, by three-dimensional printing), or the high Dk layer(s) can comprise an adhesive polymer (for example, that comprises a high Dk filler). At least some of the neighboring broad surfaces of the neighboring high Dk layers and low Dk layers can be bonded to each other via an adhesive layer. For example, FIG. 3 illustrates that an adhesive layer 30 that comprises an adhesive polymer can be located in between a low Dk layer 20 and a neighboring high Dk layer 40. FIG. 3 illustrates that the width of the repeat period of materials, Wₙ, can include the width of two adhesive layers 30, a high Dk layer 40, and a low Dk layer 20 and can be ¼ the wavelength in the polarization converter.

The adhesive polymer is not particular and can be any adhesive polymer that bonds the respective layers together. For example, if the high Dk layer 40 itself can adhere to the neighboring low Dk layer(s) 20, then the adhesive polymer can be one that is capable of bonding to said low Dk layer(s) 20. In this case, the high Dk layer 40 can comprise an adhesive polymer and a high Dk filler. Conversely, when the adhesive layer 30 is a separate layer form the neighboring low Dk layer 20 and high Dk layer 40, then it can be one that is capable of bonding to both materials of the neighboring low Dk layer 20 and high Dk layer 40. Non-limiting examples of adhesive polymers include an epoxy, an acrylic polymer, or a rubber. The adhesive layer can be an adhesive film.

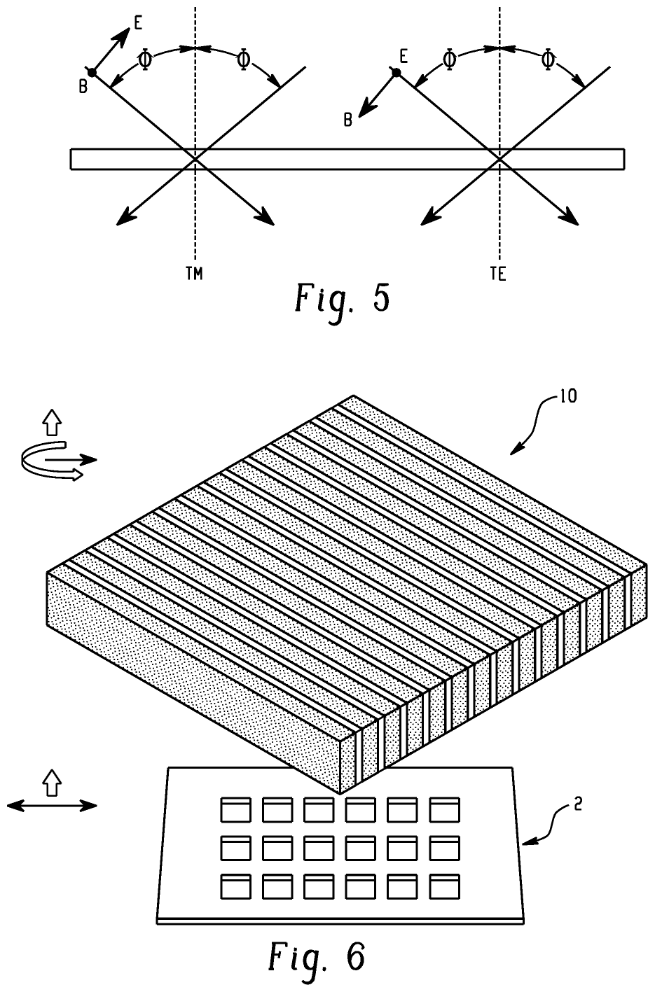

The polarization converter can comprise at least one of a frame along the x-z and y-z planes, an anti-reflection layer located on a surface of the alternating high Dk layers and low Dk layers in the x-y plane, or a stabilization layer located on a surface of the alternating high Dk layers and low Dk layers in the x-y plane. The frame can be present to increase the structural stability of the polarization converter. The presence of the anti-reflection layer(s) can help reduce the reflection of the incident electromagnetic radiation. FIG. 4A illustrates a first anti-reflection layer 52 can be located on an upper surface 12 of the dielectric polarizer and a second anti-reflection layer 54 can be located on a lower surface 14 of the dielectric polarizer. The upper surface 12 and the lower surface 14 can be defined as the broad, opposing surfaces that include or present the alternating high Dk layers and the low Dk layers. One or both of the anti-reflection layers 52, 54 can have a permittivity of 1.2 to 1.6. The anti-reflection layers 52, 54 can each independently comprise a foam.

FIG. 4B illustrates that a spacing layer 56, 58 can be located in between the polarization converter 10 and one or both of the respective anti-reflection layers 52, 54. In this configuration, the permittivity of the anti-reflection layers can be higher than if the spacer layer was not present. For example, one or both of the anti-reflection layers 52, 54 can have a permittivity of 2 to 8, while one or both of the spacer layers 56, 58 can have a permittivity of 1 to 1.2. The anti-reflection layers 52, 54 can each independently comprise a solid material. The spacer layers 56, 58 can each independently comprise a foam (for example, and aerogel) or a void space (for example, comprising a gas such as air).

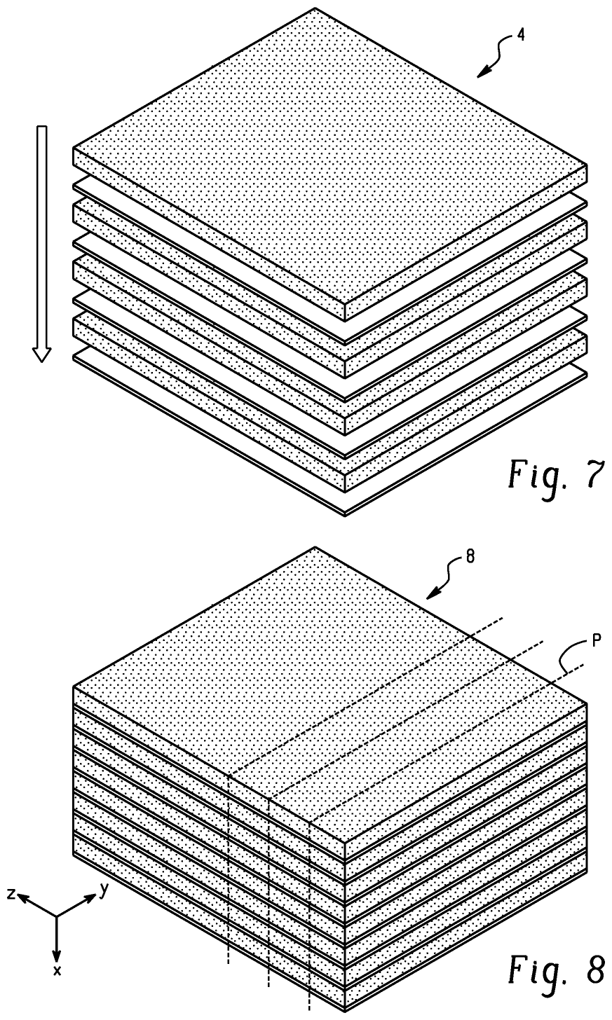

The polarization converter can be used to convert an incoming electromagnetic wave emitted from an antenna to an outgoing electromagnetic wave having a different polarization. An example of such an article can be found in FIG. 6. FIG. 6 illustrates that a linear electromagnetic wave is emitted from antenna 2 and emerges from the polarization converter 10 as a circular electromagnetic wave. It is understood that the polarization converter is not limited to changing waves to and from linear polarization and circular polarization. For example, elliptical waves can be formed or converted, or the handedness of the waves can be altered.

As illustrated in FIG. 7, the polarization converter can be prepared by first forming a multilayer stack 4 of alternating low Dk layers and high Dk layers and bonding them to form the bonded stack as illustrated in FIG. 8. The layers of the multilayer stack 4 can include prepregs that are only partially polymerized. The one or more adhesive layers 30 can be present in between neighboring layers of the multilayer stack 4. The adhesive layers 30 can be stand-alone adhesive films or can be applied as an adhesive fluid. An amount of solvent can be present on one or more surfaces of the respective layers of the multilayer stack 4. The layers of the multilayer stack 4 can be stacked without heat or pressure. Conversely, one or both of heat (for example, by increasing the temperature to 40 to 500° C.) or pressure can be used to laminate the multilayer stack 4. The respective layers of the multilayer stack 4 are bonded together to form the bonded stack 8. If the dimensions of the bonded stack 8 meet the desired dimensions of the polarization converter, then the bonded stack 8 as is can be the polarization converter. Conversely, if the height in the z-direction is too long, then the layered block 8 can be severed along an x-y plane, P, of the bonded stack 8 to form at least one polarization converter 10. The severing can comprise slicing, rope cutting, or the like.

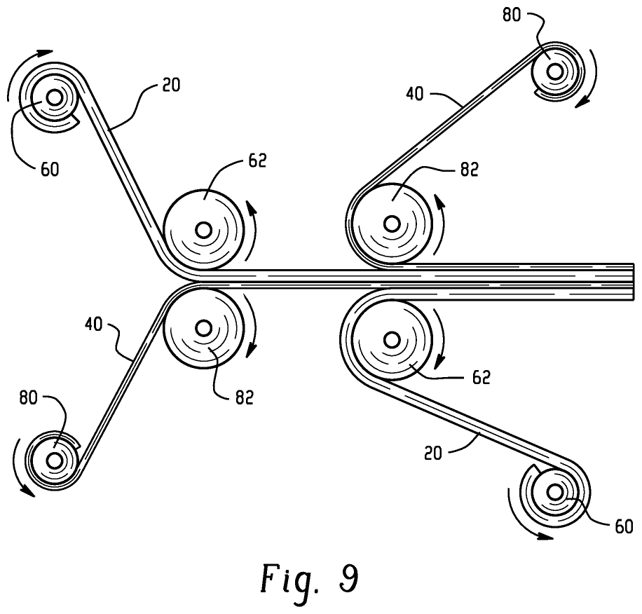

The polarization converter can be prepared using a roll-to-roll process as illustrated in FIG. 9. FIG. 9 illustrates that the low Dk layers 20 and the high Dk layer 40s can be unrolled from spools 60 and 80, respectively, and guided by guiding rolls 62 and 82, respectively to form the multilayer stack. The guiding rolls 62 and 82 can apply pressure and/or heat to form the multilayer stack or downstream rolls can be used to laminate the multilayer stack. The multilayer stack can be cut into sheets, optionally stacked upon one another, and subsequently laminated. It is noted that while only four layers are illustrated in FIG. 9, it is understood that more or less layers can be used to form the multilayer stack. Likewise, many different configurations for the spools, guiding rolls, and laminating rolls can be used to form the multilayer stack.

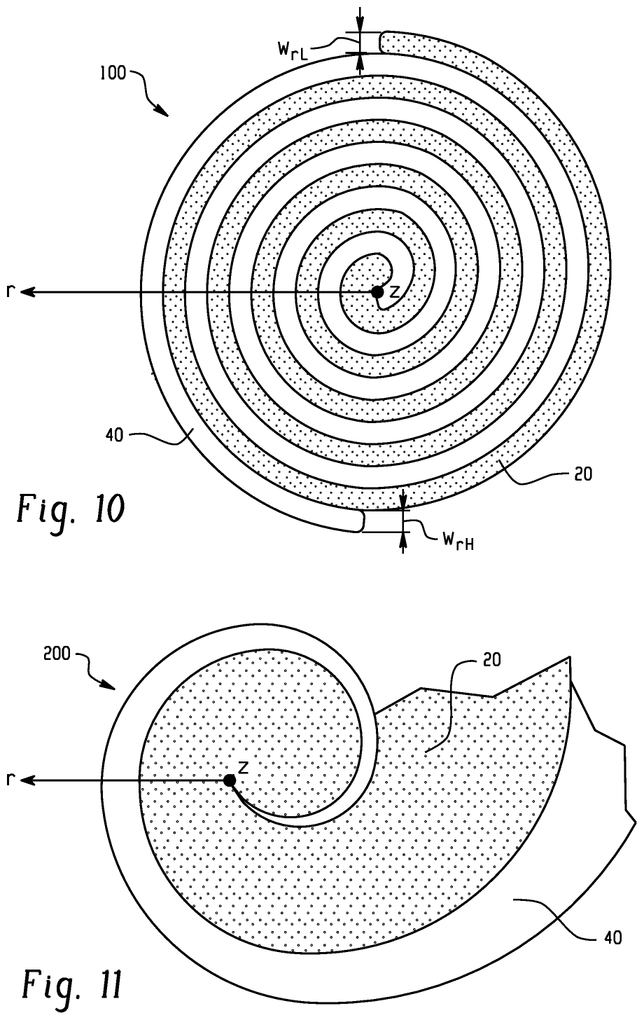

FIG. 10 and FIG. 11 illustrate that the polarization converter can have a radial configuration. Specifically, FIG. 10 illustrates that a polarization converter 100 can include a plurality of alternating high Dk layers 40 and low Dk layers 20 that alternate along a radial direction, r. A height in the axial, z-direction can be less than the diameter in the radial direction. The respective layers can each independently have a first broad surface and a second broad surface, wherein the broad surfaces of neighboring high Dk layers and low Dk layers are bonded together. FIG. 10 illustrates that the polarization converter 100 can comprise one low Dk layer 20 and one high Dk layer 40 that spiral from a center axis z, where the width of the radial low Dk layer 20, w_{rL}, or the radial high Dk layer 40, w_{rH}, can remain constant along the radial direction, r. FIG. 10 illustrates that the polarization converter 200 can comprise one low Dk layer 20 and one high Dk layer 40 that spiral from a center axis z, where the width of the radial low Dk layer 20, w_{rL}, or the radial high Dk layer 40, w_{rH}, can increase along the radial direction, r. Although not illustrated, it is noted that more than one layer of the high Dk layer 40 or the low Dk layer 20 can be present or adhesive layers can be present. Likewise, the polarization converter can comprise at least one of a frame along the outer circumference of the polarization converter, an anti-reflection layer located on a surface of the polarization converter that includes the radially alternating high Dk layers and low Dk layers, or a stabilization layer located on a surface of the radially alternating high Dk layers and low Dk layers in the x-y plane.

The radial polarization converter can be formed by rolling or spiraling around a z-axis a layered stack of at least one low Dk layer 20 and at least one high Dk layer 40. The spiraling can comprise spiraling a layered stack of the at least one low Dk layer, a first adhesive layer, the at least one high Dk layer, and a second adhesive layer located on an opposing side of the low Dk layer or the high Dk layer opposite the first adhesive layer. The radial polarization converter can be formed by spiraling at least one low Dk layer 20 or at least one high Dk layer 40 such that there is an open space between the neighboring portions of the layer along the radius; and backfilling the other of the low Dk layer 20 and at least one high Dk layer 40 into the open space. For example, a spiral of a high Dk layer 40 can be formed and a low Dk material can be foamed in the open space.

The polarization converter can comprise a plurality of alternating high Dk layers and low Dk layers that are bonded together. For example, the polarization converter can comprise a plurality of alternating high Dk layers and low Dk layers that alternate along an x-direction; wherein the respective layers each independently have a first broad surface and a second broad surface in the y-z plane; wherein neighboring broad surfaces of the respective high Dk layers and low Dk layers are bonded together; a height in the z-direction can optionally be less than the width in the x-direction and the length in the y-direction. Conversely, the polarization converter can comprise a plurality of alternating high Dk layers and low Dk layers that alternate along a radial direction; wherein a height in the axial, z-direction is optionally less than the diameter in the radial direction; wherein the respective layers each independently have a first broad surface and a second broad surface; wherein neighboring broad surfaces of the respective high Dk layers and low Dk layers are bonded together. In either case, the polarization converter can be capable of converting an incoming electromagnetic wave to an outgoing electromagnetic wave having a different polarization. At least one of the high Dk layers can each independently comprise a high Dk filler. All of the high Dk layers can each independently comprise a high Dk filler. The high Dk filler can comprise at least one of titanium dioxide, barium titanate, strontium titanate, corundum, wollastonite, Ba₂Ti₉O₂₀, solid glass spheres, hollow glass spheres, hollow ceramic spheres, quartz, boron nitride, aluminum nitride, silicon carbide, beryllia, alumina, alumina trihydrate, magnesia, mica, talc, nanoclay, or magnesium hydroxide. The low Dk layers and the high Dk layers can each independently comprise a dielectric material. At least one of the low Dk layers can comprise a foam. All of the low Dk layers can comprise a foam. At least some of the neighboring broad surfaces of the respective high Dk layers and low Dk layers can be in direct physical contact with each other. At least some of the neighboring broad surfaces of the respective high Dk layers and low Dk layers can be bonded via an adhesive layer. All of the neighboring broad surfaces of the respective high Dk layers and low Dk layers can be bonded via an adhesive layer. The polarization converter can comprise an anti-reflection layer located on a surface of the polarization converter that includes the alternating high Dk layers and low Dk layers. A spacer layer can be located in between the surface and the anti-reflection layer. At least one of the alternating high Dk layers or low Dk layers can have a patterned surface. An article can comprise the polarization converter and an antenna.

An article can comprise the polarization converter and an antenna. The article can be used in communication applications, for example, in satellite communications or cellular communications. The article can be used in radar applications, The article can be used in mm-wave imaging. The polarization converter can be used to convert microwaves (for example, having a frequency of 1 to 1,000 gigahertz and a wavelength of 0.03 to 30 centimeters), radio frequency waves (for example, having a frequency of 3 kilohertz to 300 gigahertz and a wavelength of 1 millimeter to 100 kilometers), or millimeter waves (for example, having a frequency of 30 to 300 gigahertz and a wavelength of 1 to 10 millimeters).

The following examples are provided to illustrate the present disclosure. The examples are merely illustrative and are not intended to limit devices made in accordance with the disclosure to the materials, conditions, or process parameters set forth therein.

### EXAMPLES

Simulations were performed using Ansys HFSS 3D electromagnetic simulation software.

### Examples 1-5: Simulations of Polarization Converters

The center frequencies of polarization converters illustrated in FIG. 1 were determined using the parameters outlined in Table 1. The simulations of Example 1 were run over thickness values ranging from 1.7 to 11 mm and weight ranges from 65 to 450 grams per square foot at frequencies ranging from 12 to 80 GHz. The polarization converter of Example 2 included two anti-reflection layers located on opposing surfaces as illustrated in FIG. 4, where the anti-reflection layers each had thickness values of 7.4 mm such that the combined thickness, T, was 25.4 mm. FIG. 5 shows that the incident angle ϕ is relative the normal to the polarization convertor. In Example 2, the simulations were run over thickness values ranging from 3.7 to 25 mm and weight ranges from 100 to 700 grams per square foot at frequencies ranging from 12 to 80 GHz. The polarization converters of Examples 1 and 3-5 did not include anti-reflection layers.

TABLE 1

| Example | 1 | 2 |
|---|---|---|
| Width of the high Dk layer, W_{H} (mm) | 0.28 | 0.28 |
| Width of the low Dk layer, W_{L} (mm) | 1.6 | 1.6 |
| Thickness of the converter, H (mm) | 12.7 | 12.7 |
| Dk of the high Dk layer, D_{kH} | 12 | 12 |
| Dk of the low Dk layer, D_{kL} | 1.15 | 1.15 |
| Reflection layers | N | Y |
| Center Frequency (GHz) | 11.3 | 11.1 |

Incident EM mode: polarization along the x-axis, TM

| | | |
|---|---|---|
| 3-dB Axial Ratio Bandwidth (%) | 46 | 40 |
| Max incident Angle from Normal | ±60° | ±60° |
| Insertion loss, typical (dB) | 0.4 | 0.2 |
| Insertion loss, max (dB) | 0.8 | 0.3 |
| Reflection coefficient (dB) | −11 | −14 |

Incident EM mode: polarization along the y-axis, TE

| | | |
|---|---|---|
| 3-dB Axial Ratio Bandwidth (%) | 35 | 33 |
| Max incident Angle from Normal | ±60° | ±60° |
| Insertion loss, typical (dB) | 0.5 | 0.4 |
| Insertion loss, max (dB) | 1.1 | 0.7 |
| Reflection coefficient (dB) | −10 | −12 |

Table 1 shows that for TE to TM conversion, 46% 3-dB bandwidth TM and 35% 3-dB bandwidth TE are achieved (12 to 80 GHz) for a center frequency of 11.3 GHz. Table 1 further shows that inclusion of the anti-reflection layers in Example 2 resulted in a decrease in the 3-dB bandwidth for TE to TM conversion, to 40% 3 dB bandwidth TM and 33% 3-dB bandwidth TE are achieved (12 to 80 GHz) for a center frequency of 11.1 GHz. Examples 1 and 2 further show that inclusion of the anti-reflection layers further decreases the typical and maximum insertion values. In both examples 1 and 2 the maximum incident angles were up to ±60°.

Three additional polarization converters were simulated as shown in Table 2.

TABLE 2

| Example | 3 | 4 | 5 |
|---|---|---|---|
| Width of the high Dk layer, | 0.28 | 0.04 | 0.2 |
| W_{H} (mm) | | | |
| Width of the low Dk layer, | 1.6 | 0.23 | 0.8 |
| W_{L} (mm) | | | |
| Thickness of the converter, H | 12.7 | 1.9 | 1.9 |
| (mm) | | | |
| Dk of the high Dk layer, D_{kH} | 12 | 12 | 8 |
| Dk of the low Dk layer, D_{kL} | 1.1 | 1.1 | 1.05 |
| Center Frequency (GHz) | 12 | 80 | 80 |

Set forth below are non-limiting aspects of the present disclosure.

Aspect 1: A polarization converter comprising: a plurality of alternating high Dk layers and low Dk layers that alternate along an x-direction; wherein the respective layers each independently have a first broad surface and a second broad surface in the y-z plane; wherein neighboring broad surfaces of the respective high Dk layers and low Dk layers are bonded together; wherein the polarization converter is capable of converting an incoming electromagnetic wave to an outgoing electromagnetic wave having a different polarization.

Aspect 2: The polarization converter of Aspect 1, wherein a height in the z-direction is less than the width in the x-direction and the length in the y-direction.

Aspect 3: A polarization converter comprising: a plurality of alternating high Dk layers and low Dk layers that alternate along a radial direction; wherein a height in the axial, z-direction is optionally less than the diameter in the radial direction; wherein the respective layers each independently have a first broad surface and a second broad surface; wherein neighboring broad surfaces of the respective high Dk layers and low Dk layers are bonded together; wherein the polarization converter is capable of converting an incoming electromagnetic wave to an outgoing electromagnetic wave having a different polarization.

Aspect 4: The polarization converter of Aspect 3, wherein the radial width of one or both of the alternating high Dk layers or low Dk layers is constant with increasing radius.

Aspect 5: The polarization converter of any of Aspects 3 to 4, wherein the radial width of one or both of the alternating high Dk layers or low Dk layers varies with increasing radius.

Aspect 6: The polarization converter of any one of the preceding aspects, wherein at least one of or wherein all of the high Dk layers each independently comprise a high Dk filler.

Aspect 7: The polarization converter of Aspect 6, wherein the high Dk filler comprises at least one of titanium dioxide (such as rutile and anatase), barium titanate, strontium titanate, silica (including fused amorphous silica), corundum, wollastonite, Ba₂Ti₉O₂₀, solid glass spheres, hollow glass spheres, hollow ceramic spheres, quartz, boron nitride, aluminum nitride, silicon carbide, beryllia, alumina, alumina trihydrate, magnesia, mica, talc, nanoclay, or magnesium hydroxide.

Aspect 8: The polarization converter of any one of the preceding aspects, wherein the low Dk layers and the high Dk layers each independently comprise a dielectric material, for example, at least one of a polyurethane, a polyimide, a polyolefin (for example, a polyethylene or a polypropylene), a poly(meth)acrylamide, a polyetherimide, a fluoropolymer, a polybutadiene, a polyisoprene, a polyetheretherketone, a polyester (for example, a polyethylene terephthalate), or a polystyrene.

Aspect 9: The polarization converter of any one of the preceding aspects, wherein at least one of or all of the low Dk layers comprises a foam.

Aspect 10: The polarization converter of any one of the preceding aspects, wherein at least some of the neighboring broad surfaces of the respective high Dk layers and low Dk layers are in direct physical contact with each other; or wherein at least some of the high Dk layers comprise an adhesive and wherein the broad surfaces of the respective high Dk layers comprising the adhesive are in direct physical contact with the broad surfaces of the neighboring low Dk layers.

Aspect 11: The polarization converter of any one of the preceding aspects, wherein at least some of the neighboring broad surfaces of the respective high Dk layers and low Dk layers are bonded via an adhesive layer.

Aspect 12: The polarization converter of any one of the preceding aspects, further comprising an anti-reflection layer located on a surface of the alternating high Dk layers and low Dk layers. A spacer layer can be located in between the anti-reflective layer and the polarization converter.

Aspect 13: The polarization converter of any one of the preceding aspects, wherein at least one of the alternating high Dk layers or low Dk layers has a patterned surface.

Aspect 14: An article comprising the polarization converter of any one of the preceding aspects and an antenna.

Aspect 15: A method of making the polarization converter of any one of Aspects 1, 2, or 6-14, comprising bonding neighboring layers of a multilayer stack of a plurality of alternating low Dk layers and high Dk layers to form the polarization converter. The method can comprise roll-to-roll processing of the low Dk layers and the high Dk layers to form the multilayer stack.

Aspect 16: The method of Aspect 15, wherein the bonding forms an intervening bonded stack and the method further comprises severing the bonded stack along an x-y plane to form the polarization converter.

Aspect 17: The method of any of Aspects 15 to 16, wherein the multilayer stack includes an adhesive film located in between at least two neighboring layers of the multilayer stack.

Aspect 18: The method of any of Aspects 15 to 17, wherein the bonding comprises applying at least one of an increased temperature or a pressure.

Aspect 19: A method of making the polarization converter of any of Aspects 3 to 13, comprising: spiraling at least one low Dk layer and at least one high Dk layer around an x-axis and bonding the neighboring layers together to form the polarization converter.

Aspect 20: The method of Aspect 19, further comprising spiraling a layered stack of the at least one low Dk layer, a first adhesive layer, the at least one high Dk layer, and a second adhesive layer located on an opposing side of the low Dk layer or the high Dk layer opposite the first adhesive layer.

Aspect 21: A method of making the polarization converter of any of Aspects 3 to 13, comprising: spiraling one of a low Dk layer or at least one high Dk layer around an x-axis with an intervening space between the neighboring layers; and filling the intervening space with the other of the low Dk layer and the high Dk layer.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

As used herein, “a,” “an,” “the,” and “at least one” do not denote a limitation of quantity, and are intended to cover both the singular and plural, unless the context clearly indicates otherwise. For example, “an element” has the same meaning as “at least one element,” unless the context clearly indicates otherwise. The term “combination” is inclusive of blends, mixtures, alloys, reaction products, and the like. Also, “at least one of” means that the list is inclusive of each element individually, as well as combinations of two or more elements of the list, and combinations of at least one element of the list with like elements not named.

The term “or” means “and/or” unless clearly indicated otherwise by context. Reference throughout the specification to “an aspect”, “another aspect”, “some aspects”, and so forth, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being neighboring another element, it is the element directly to a side of the other element. The neighboring element can be directly on the other element or intervening elements can also be present such as an adhesive layer. When an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

The endpoints of all ranges directed to the same component or property are inclusive of the endpoints, are independently combinable, and include all intermediate points and ranges. For example, ranges of “up to 25 vol %, or 5 to 20 vol %” is inclusive of the endpoints and all intermediate values of the ranges of “5 to 25 vol %,” such as 10 to 23 vol %, etc.).

The suffix “(s)” as used herein is intended to include both the singular and the plural of the term that it modifies, thereby including one or more of that term (e.g., the colorant(s) includes one or more colorants). The terms “first,” “second,” and the like, as used herein do not denote any order, quantity, or importance, but rather are used to distinguish one element from another. The terms “front”, “back”, “bottom”, and/or “top” are used herein, unless otherwise noted, merely for convenience of description, and are not limited to any one position or spatial orientation.

Unless defined otherwise, technical and scientific terms used herein have the same meaning as is commonly understood by one of skill in the art to which this disclosure belongs. As used herein, the term “(meth)acryl” encompasses both acryl and methacryl groups.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

What is claimed is:

1. A polarization converter comprising:
a plurality of alternating high Dk layers and low Dk layers that alternate along an x-direction; wherein the respective layers each independently have a first broad surface and a second broad surface in the y-z plane;
wherein neighboring broad surfaces of the respective high Dk layers and low Dk layers are bonded together;
wherein the polarization converter is capable of converting an incoming electromagnetic wave to an outgoing electromagnetic wave having a different polarization.

2. The polarization converter of claim 1, wherein a height in the z-direction is less than the width in the x-direction and the length in the y-direction.

3. The polarization converter of claim 1, wherein at least one of or wherein all of the high Dk layers each independently comprise a high Dk filler.

4. The polarization converter of claim 3, wherein the high Dk filler comprises at least one of titanium dioxide, barium titanate, strontium titanate, silica, corundum, wollastonite, Ba₂Ti₉O₂₀, solid glass spheres, hollow glass spheres, hollow ceramic spheres, quartz, boron nitride, aluminum nitride, silicon carbide, beryllia, alumina, alumina trihydrate, magnesia, mica, talc, nanoclay, or magnesium hydroxide.

5. The polarization converter of claim 1, wherein the low Dk layers and the high Dk layers each independently comprise a dielectric material.

6. The polarization converter of claim 1, wherein at least one of or all of the low Dk layers comprises a foam.

7. The polarization converter of claim 1, wherein at least some of the high Dk layers comprise an adhesive and wherein the broad surfaces of the respective high Dk layers comprising the adhesive are in direct physical contact with the broad surfaces of the neighboring low Dk layers.

8. The polarization converter of claim 1, wherein at least some of the neighboring broad surfaces of the respective high Dk layers and low Dk layers are bonded via an adhesive layer.

9. The polarization converter of claim 1, further comprising an anti-reflection layer located on a surface of the alternating high Dk layers and low Dk layers; where a spacer layer is optionally located in between the anti-reflective layer and the polarization converter.

10. The polarization converter of claim 1, wherein at least one of the alternating high Dk layers or low Dk layers has a patterned surface.

11. An article comprising the polarization converter of claim 1 and an antenna.

12. A method of making the polarization converter of claim 1, comprising:
bonding neighboring layers of a multilayer stack of a plurality of alternating low Dk layers and high Dk layers to form the polarization converter.

13. The method of claim 12, wherein the bonding forms an intervening bonded stack and the method further comprises severing the bonded stack along an x-y plane to form the polarization converter.

14. The method of claim 12, wherein the multilayer stack includes an adhesive film located in between at least two neighboring layers of the multilayer stack.

15. The method of claim 12, wherein the bonding comprises applying at least one of an increased temperature or a pressure.

16. The method of claim 12, further comprising forming the multilayer stack using a roll-to-roll process.

17. A polarization converter comprising:
a plurality of alternating high Dk layers and low Dk layers that alternate along a radial direction; wherein a height in the axial, z-direction is optionally less than the diameter in the radial direction; wherein the respective layers each independently have a first broad surface and a second broad surface;
wherein neighboring broad surfaces of the respective high Dk layers and low Dk layers are bonded together;
wherein the polarization converter is capable of converting an incoming electromagnetic wave to an outgoing electromagnetic wave having a different polarization.

18. The polarization converter of claim 17, wherein the radial width of one or both of the alternating high Dk layers or low Dk layers is constant with increasing radius.

19. The polarization converter of claim 17, wherein the radial width of one or both of the alternating high Dk layers or low Dk layers varies with increasing radius.

20. A method of making the polarization converter of claim 17, comprising:
spiraling at least one low Dk layer and at least one high Dk layer around an x-axis and bonding the neighboring layers together to form the polarization converter; or spiraling one of a low Dk layer or at least one high Dk layer around an x-axis with an intervening space between the neighboring layers; and filling the intervening space with the other of the low Dk layer and the high Dk layer.
